(19) United States
(12) Patent Application Publication
(10) Pub. No.: US 2025/0284766 A1
(43) Pub. Date: Sep. 11, 2025

(54) DEEP LEARNING CONVOLUTION ACCELERATION METHOD USING BIT-LEVEL SPARSITY, AND PROCESSOR

(71) Applicant: Institute of Computing Technology, Chinese Academy of Sciences, Beijing (CN)

(72) Inventors: Hang LU, Beijing (CN); Xiaowei LI, Beijing (CN)

(73) Assignee: Institute of Computing Technology, Chinese Academy of Sciences, Beijing (CN)

(21) Appl. No.: 18/561,165

(22) PCT Filed: Feb. 22, 2022
(86) PCT No.: PCT/CN2022/077275

§ 371 Date: Nov. 15, 2023

(30) Foreign Application Priority Data
Oct. 27, 2021 (CN) 202111254887.3

(51) Int. Cl. G06F 17/16; G06F 9/50

(52) U.S. Cl. CPC G06F 17/16; G06F 9/5027; G06F 2101/10

(57) ABSTRACT

The present application provides a deep learning convolution acceleration method using bit-level sparsity and a processor. Comprises: selecting the maximum sum of the exponents from all data pairs to be convolved as a maximum exponent; arranging mantissas of the original weights in a computation sequence to form a weight matrix, and uniformly aligning each row of the weight matrix to the maximum exponent and removing slack bits to obtain a reduced matrix, allowing essential bits in each column of the reduced matrix to fill the vacancies according to the computation sequence, after removing null rows in the intermediate matrix, placing zeros at vacancies of the matrix to obtain an interleaved weight matrix, sending the weight segments in each row of the interleaved weight matrix and the mantissa of the corresponding activation to an adder tree for processing summation, by shifting and adding the sum result to obtain a convolution result.

### BACKGROUND OF THE APPLICATION

### 1. Technical Field

The present application relates to the field of design of deep learning accelerator, and particularly to a deep learning convolution acceleration method using bit-level sparsity, and an intelligent processor.

### 2. Related Art

In order to reach higher accuracy, scale of deep learning models is continuously increasing. Correspondingly, performance of deep learning accelerators shall follow the change. However, due to limits such as battery life, power budgeting and cost, in particular, for embedded devices such as robots, UAVs and intelligent mobiles, hardware designers are reluctant to input more computing resource based on development of deep neural network (DNN). Therefore, it is quite advisable to improve efficiency of the accelerators in high performance and low consumption scenarios.

Previously, massive studies mainly focus on tapping the maximum potential of sparsity of weight/activation, and parallel executing effective multiply-accumulate operation (MAC) as much as possible. However, sparsity is not always enough, but changes according to different models, even respective layers in the same model. For example, due to the non-linear activation function, activations have more sparsity. However, as for the weights, except training with the criterion L1, sparsity is often low. Moreover, even if the activations, zeros may be produced only through functions such as ReLU or PReLu, and in order to solve this challenge, some tasks create more sparsity space for pruning by identifying parts approaching “zeros” in a set of operands, or carrying out tedious sparsity (repeated) training.

The tasks in the past proposed a series of bit-serial accelerators, and utilized rich bit-level sparsity to different extents. FIG. 1 compares computation paradigms of three types of accelerator PEs through examples. The earlier bit-parallel accelerator (FIG. 1(a)) and the bit-serial accelerator use bit-level arithmetic with the same numerical value to compute inner products. For example, a 8b×8b product is divided into eight products of 1b×8b, and the same result is produced by serial (step 1 in FIG. 1(b)) organizing and inputting weights. FIG. 1(c) is a computation example of the present application. FIG. 1 compares computation and distribution between the bit-interleaved PE and the previous bit-parallel/serial PE in a fixed-point mode. White background is marked to be sparse bits (0 bits), and gray background is marked to be essential bits (1 bits). In (a) bit-parallel PE, Step1 is to parallel organize weights, and Step2 executes the MAC. In (b) bit-serial PE, Step1 is to serial organize weights, Step2 synchronizes values of necessary bits, and Step3 executes the “bit-serial” MAC. In (c) bit-interleaved PE, Step1 is to parallel organize weights, but Step2 executes serial MAC along the value of each bit, and does not perform synchronization operation.

However, the current space for exploring based on sparsity of the bits has come to the end. As is viewed from software, if lossless accuracy is the first design essence, a compression ratio cannot exceed an apparent margin. No matter using which pruning method, it takes a lot of time to explore such margin to balance accuracy and size of the model. As is viewed from implementation of hardware, utilization of sparsity of values also inevitably leads to design of more complex accelerators. For example, the cost of enlarging the storage system to suit for a continuously growing exponent is to increase memory access and affect peak computing throughput.

Meanwhile, the prior art also has other issues. As shown in FIG. 1(a), in order to release the maximum potential of the bit sparsity, it's best to skip zero bits as much as possible. However, it is difficult to predict position of zero bits in each 8b operand, especially, after fixed-point quantization. The reason is to make full use of limited bit widths to express the numerical range after quantization, such that the zero bits and the necessary bits 1 are randomly interleaved. In order to fully use bit sparsity of the parameter itself, synchronization operation shall be carefully executed, as shown in step 2 of FIG. 1(b), and before finally determining the bit-serial MAC in the step 3, synchronization must be firstly performed.

The synchronization methods used previously comprise intermediate intensive scheduling and hardware-level Booth coding. However, the key weakness of these methods is originated from difficulty in determining one uniform mode to describe position of synchronous sparsity. One direct consequence is that the ongoing MAC operation must be stopped to adjust importance of the bits, and as compared to the corresponding bit-parallel method, the cost is to weaken the throughput. For example, in FIG. 1(b), the three MAC calculations indicated by the arrows cannot be completed at the same time and must wait for the importance of the bits, otherwise it will result in incorrect results. Meanwhile, in implementation of hardware, complexity is also increased, because Booth coding need an additional circuit to encode and store weight bits. Another weakness is that the serial organization cannot support floating-point operation, i.e., usage scenarios of the bit-serial accelerator are seriously limited, and cannot be deployed in many usage scenarios.

### SUMMARY OF THE APPLICATION

An object of the present application is to solve the problem of design efficiency and generality of the current deep learning accelerators, and the present application proposes a computing method using bit sparse parallelism, i.e., “bit-interleaved” computing method, and designs a hardware accelerator, i.e., Bitlet, which carries out the “bit-interleaved” computing method.

With respect to deficiencies of the prior art, the present application provides a deep learning convolution acceleration method using bit-level sparsity, comprising:
step 1, acquiring multiple groups of data pairs to be convolved, wherein each group of data pairs is formed of an activation and a corresponding original weight, and the activation and the original weight are both floating-point numbers;
step 2, summing exponents of the activation and the original weight in each group of data pairs to obtain a sum of the exponents of each group of data pairs, and selecting the maximum sum of the exponents from all data pairs as a maximum exponent;
step 3, arranging mantissas of the original weights in a computation sequence to form a weight matrix, and uniformly aligning each row of the weight matrix to the maximum exponent to obtain an alignment matrix;
step 4, removing slack bits in the alignment matrix to obtain a reduced matrix with vacancies, allowing essential bits in each column of the reduced matrix to fill the vacancies according to the computation sequence to form an intermediate matrix, and after removing null rows in the intermediate matrix, placing zeros at vacancies of the matrix to obtain an interleaved weight matrix, wherein each row of the interleaved weight matrix serves as a necessary weight; and
step 5, obtaining, according to a correspondence relationship between the activations and the essential bits in the original weights, positional information of the activation corresponding to each bit of the necessary weight, sending the necessary weight to a split accumulator, which divides the necessary weight by bit into multiple weight segments, sending the weight segments and the mantissa of the corresponding activation to an adder tree for processing summation according to the positional information, and obtaining an output feature map as a convolution result of the multiple groups of data pairs by means of executing shift-and-add on the processing result.

In the deep learning convolution acceleration method using bit-level sparsity, the activations are pixel values of an image.

The present application further provides a processor for carrying out the deep learning convolution acceleration method using bit-level sparsity.

The processor comprises:
a pre-process module for acquiring multiple groups of data pairs to be convolved, wherein each group of data pairs is formed of an activation and a corresponding original weight, and the activation and the original weight are both floating-point numbers; summing exponents of the activation and the original weight in each group of data pairs to obtain a sum of the exponents of each group of data pairs, and selecting the maximum sum of the exponents from all data pairs as a maximum exponent;
an exponent alignment module for arranging mantissas of the original weights in a computation sequence to form a weight matrix, and uniformly aligning each row of the weight matrix to the maximum exponent to obtain an alignment matrix;
a weight interleaved module for removing slack bits in the alignment matrix to obtain a reduced matrix with vacancies, allowing essential bits in each column of the reduced matrix to fill the vacancies according to the computation sequence to form an intermediate matrix, and after removing null rows in the intermediate matrix, placing zeros at vacancies of the matrix to obtain an interleaved weight matrix, wherein each row of the interleaved weight matrix serves as a necessary weight; and
a circulating register for extracting essential bits in the necessary weight, and obtaining positional information of the activation corresponding to each bit of the necessary weight from the corresponding mantissa in the mantissas of all activations; and
a split accumulator for dividing the necessary weight by bit into multiple weight segments, sending the weight segments and the mantissa of the corresponding activation to an adder tree for processing summation according to the positional information, and obtaining an output feature map as a convolution result of the multiple groups of data pairs by means of executing shift-and-add on the processing result.

In the processor, the activations are pixel values of an image.

As can be known from the above solutions, advantages of the present application lie in:
(1) as compared to the newest high-performance GPU, training/inference efficiency is improved by 81 or 21 times, respectively;
(2) as compared to the most advanced fixed-point accelerators, the speed/efficiency is improved by 15 or 8 times, respectively;
(3) an area of the designed accelerator is 1.5 mm², and in the TSMC 28 nm process, the accelerator has an area of 0.039 mm², powers of 570 mW (32-bit floating-point number mode), 432 mW (16-bit fixed-point number mode) and 365 mW (8-bit fixed-point mode).

(4) the accelerator has high configurability.

### BRIEF DESCRIPTION OF THE DRAWINGS

FIG. 1 is a comparison diagram of computation and distribution between the bit-interleaved PE and the bit-parallel/serial PE in a fixed-point mode.

FIG. 2 is a schematic diagram of sparse parallelism.

FIG. 3 is a schematic diagram of bit-interleaved concept.

FIG. 4 is a structural diagram of a BCE module.

FIG. 5 is a structural diagram of a Bitlet accelerator.

### DETAILED DESCRIPTION

The weaknesses of the technique are mainly caused by using sparsity of values. In research of the present application, we find out that “bit sparsity” is an inherent finer sparsity for “zero bits” in each operand, not zeros of coarseness. The floating-point numbers or fixed-point numbers are used to represent weights or activations, and in different DNN models, zero bit percentage can reach 45% to 77%. Skipping zero bits in the operand does not affect result, which also means that if strictly executing bit-level valid computation, acceleration can be directly obtained without any effort at software level. Therefore, the present application accelerates training and inference phases using rich bit-level sparse parallelism to serve general-purpose deep learning at cloud/edge end.

In table 1, we classify the most advanced accelerators based on sparsity. In the early bit-parallel accelerators, i.e., Cambricon and SCNN, research on sparsity only focuses on the numerical values. More zero sparsity space is created to release potential of these accelerators by using pruning at software level. Considering that bit sparsity is rich in weights and activations, the recent research on the bit-serial accelerators has focused on the bit-level sparsity. Recently, Laconic uses “terms” to serial extract necessary bits after performing Booth coding, and proposes a low cost LPE to reduce an increase of power consumption due to frequent coding/decoding. Tactical solves the problem of sparsity at bit level of weights and activations. The design concept is similar with that of Pragmatic, which are both to optimize invalid operation by skipping zero bits, but Tactical skips zero weights depending on a front-end irrelevant to data types, and a software scheduler to maximize possibility of skipping the weight. Currently, there are also some sparsity design modes following bit-serial computation. For example, Stripes and UNPU achieve bit serialization of the fixed-point operands without avoiding sparsity. Bit-fusion supports a fast space and time combination to accelerate bit serialization, but still cannot well utilize sparsity of bits.

TABLE 1

| Philos. | Design | Sparsity Exploited | Preci. V. | | Training Support |
|---|---|---|---|---|---|
| Bitparallel | Eyeriss, | N/A | 16 | b | No |
| | DianNao | | | | |
| | Cambricon-S, | A/W-value | 16 | b | No |
| | EIE | | | | |
| | SCNN | A&W-value | 16 | b | No |
| bit serial | UNPU, | N/A | 1~16 | b | No |
| | Stripes | | | | |
| | Bit Fusion | N/A | 2, 4, 8, 16 | b | No |
| | Pragmatic | A-/W-bit | 1~16 | b | No |
| | Bit Tactical | A-bit&W-value | 1~16 | b | No |
| | Laconic | A&W-bit | 1~16 | b | No |

| | | | | |
|---|---|---|---|---|
| bit interleaving | Bitlet (this work) | W-bit&W-value, | fp 32/16, | Yes |
| | | (or A-bit&A-value) | 1~24 b | |

Meanwhile, the previous tasks have proved that the bit-level sparsity is rich. However, the previous tasks only focus on exploring the strategy of skipping zero bits in specific weights, while not exploring sparsity between the weights.

As shown in FIG. 2, each point in the figure represents a ratio of all weights in the convolution kernel to zero bits of the bit lane. It shows that about 50% of bits in all convolution kernels is 0. On an X axis of the figure, sparsity only includes mantissas (23/10 bit in the floating-point 32-/16-bit), and in representation of int8 bit accuracy, only includes seven valid bits, not including sign bits. FIG. 2 illustrates bit sparsity of different convolution kernels, and it is observed that the weight sparsity on each bit value is consistent. The X axis represents a bit value of the mantissa, so there are total 23 bits, not including hidden bits 1 in the format of the standard floating-point 32. Each point represents a ratio of zero bits on exponent of the bit in one convolution kernel. Taking ResNet152 and MobileNetV2 for example, a first half part (bit0 to bit16) of the mantissa has obvious gathering, which means that the number of 0 and 1 on the bit value is almost equal. This provides favorable conditions for parallel reading the weights into the accelerator and serial computation. Moreover, starting from bit17 to bit23, these points are almost padded at 100% (long mantissa in fp23 digit) on the Y axis, which means that most bits are 0. Since the floating-point multiplier is designed to cover any cases of the operands, the floating-point multiplier does not distinguish the less optimum case. This is also the root cause why the floating-point multiplication and addition operation and convolution operation (MAC) are difficult to be accelerated.

Although the fixed-point accuracy represents success in efficient DNN inference, it also causes that the accelerators designed for the fixed-point accuracy can achieve inference only, such that these designs are difficult to be applied to general-purpose scenarios. For example, training of the DNN still depends on floating-point backpropagation to ensure adjustment of the models to the floating points, but still shall satisfy the real-time requirement, in particular, when the fixed-point accuracy cannot satisfy the corresponding accuracy. In an ideal case, the accelerators shall suit for most use cases, and shall cooperatively provide enough convenience and flexibility for terminal users.

Based on the exploration, the present application provides a parallel design mode based on bit-interleaved sparsity. Advantage of the bit-serial accelerators is to effectively utilize sparsity of the bits. However, throughput provided by the bit-serial accelerators is relatively lower than that of the corresponding bit-parallel accelerators. On the basis of the two design concepts, the present application provides bit-interleaved design, and combining with the advantage of the design while avoiding disadvantage, such design mode can significantly exceed the preceding bit-serial/parallel mode. The accelerator Bitlet uses the bit-interleaved design concept, and also supports several accuracies comprising floating points and fixed points. Such configurable properties allow Bitlet to suit for high performance, and also suit for low consumption scenarios.

To make the above features and effects of the present application clearer, hereinafter explanations are made in details with reference to examples and the accompanying drawings.

Hereinafter the present application is explained in details:

### 1. “Bit Interleaving”

Without loss of generality, a floating-point operand is consisting of three parts, a sign bit, a mantissa and an exponent, and follows the standard IEEE754, which is also the most common floating-point standard in the industry. If we use single accuracy floating-point number (fp32), a bit width of the mantissa is 23 bits, a bit width of the exponent is 8 bits, and the remaining bit is the sign bit. One single accuracy floating-point weight may be represented by fp=(−1)^{s}1·m×2^{e-127}, and e is adding 127 at the actual position of decimal point of the floating-point number. We compute partial sum of convolution using MAC with a series of floating-point 32-bit single accuracy numbers.

$${\sum }_{i = 0}^{N - 1} {A}_{i} \times {W}_{i} = {\sum }_{i = 0}^{N - 1} {( - 1 )}^{{S}_{{W}_{i}}} {A}_{i} \times {M}_{{W}_{i}} \times {2}^{{E}_{{W}_{i}}} \qquad ( 1 )$$

Formula 1: converting Wᵢ into fp32 representation, wherein M_{W}_{ᵢ} and E_{W}_{ᵢ} are simplified expressions of 1·m_{W}_{ᵢ} and e_{W}_{ᵢ}−127·M_{W}_{ᵢ} includes a hidden mantissa 1, and in actual memory, according to the standard IEEE-754, the bit is hidden. M_{W}_{ᵢ} is the mantissa with a fixed width, which is total 24 bits, so M_{W}_{ᵢ} is further divided to obtain the partial sum represented by bits.

$${\sum }_{i = 0}^{N - 1} {A}_{i} \times {W}_{i} = {\sum }_{i = 0}^{N - 1} {\sum }_{b = 0}^{- 23} [ {( - 1 )}^{{S}_{{W}_{i}}} {A}_{i} ] \times {2}^{{E}_{{W}_{i}} + b} \times {M}_{{W}_{i}} \qquad ( 2 )$$

$$= {\sum }_{i = 0}^{N - 1} {\sum }_{b = 0}^{- 23} [ {( - 1 )}^{{S}_{{W}_{i}} ⊕ {S}_{{A}_{i}}} \cdot {A}_{i} ] \times {2}^{{E}_{{W}_{i}} + {E}_{{A}_{i}} + b} \times {M}_{{W}_{i}}^{b} \qquad ( 3 )$$

wherein M_{W}_{ᵢ}^{b} is the bitb of M_{W}_{ᵢ} represented by binary system. If Aᵢ is represented by a binary format of IEEE-754, the formula 2 may be modified to formula 3. Moreover, if Eᵢ=E_{W}_{ᵢ}+E_{A}_{ᵢ}, the formula 3 may be modified to

$${\sum }_{i = 0}^{N - 1} {\sum }_{b = 0}^{- 23} [ {( - 1 )}^{{S}_{{W}_{i}} ⊕ {S}_{{A}_{i}}} \cdot {A}_{i} ] \times {2}^{{E}_{i} - {E}_{max}} \times {2}^{{E}_{max} + b} {M}_{{W}_{i}}^{b} \qquad ( 4 )$$

$$= {\sum }_{i = 0}^{N - 1} {\sum }_{b = {E}_{i -} {E}_{max}}^{{E}_{i} - {E}_{max} - 23} [ {( - 1 )}^{{S}_{{W}_{i}} ⊕ {S}_{{A}_{i}}} \cdot ( {M}_{{A}_{i}} \times {M}_{{W}_{i}}^{b} ) ] \times {2}^{{E}_{max} + b} \qquad ( 5 )$$

According to formula 5, it can be inferred that a result of N fp32 MACs corresponds to a series of bit-level operations of the corresponding mantissas. Specifically, if M_{W}_{ᵢ}^{b}=1, summation of N MACs is converted into summation of N signed M_{A}_{ᵢ} (represented by

$${( - 1 )}^{{S}_{{W}_{i}} ⊕ {S}_{{A}_{i}}}$$

), andon such basis, left (right) shifting 2^{E}^{ₘₐₓ}^{+b} is performed.

The analysis shows that in the case of considering sparsity, partial sum of the floating-point numbers can be converted into bit-level operations. The product is mainly formed of the mantissa M_{A}_{ᵢ}, but whether it has contribution to the product, it is determined by M_{W}_{ᵢ}^{b} in the formula 5. Such bit-level sparsity also can be utilized in bit interleaving. Each bit value has a fair percentage of zero bits, so if M_{W}_{ᵢ}^{b}=0, but another weight Wⱼ on the same bitb is the bit 1, M_{W}_{ᵢ}^{b} can be replaced by M_{W}_{ⱼ}^{b}, such that different weight bits are interleaved on the same bit row. In the same cycle, the mantissas M_{A}_{ⱼ} and M_{A}_{ᵢ} participate in operation of the partial sum, i.e., accelerating computation using sparsity.

The computing theory also includes fixed-point accuracy. In the formula 5, Eₘₐₓ and Eᵢ−Eₘₐₓ are not necessary, because the fixed-point accuracy shows no exponents. The present application explicitly describes how bit interleaving works in the floating-point 32-bit accuracy weights, and supports design details of the multiple accuracy Bitlet accelerator.

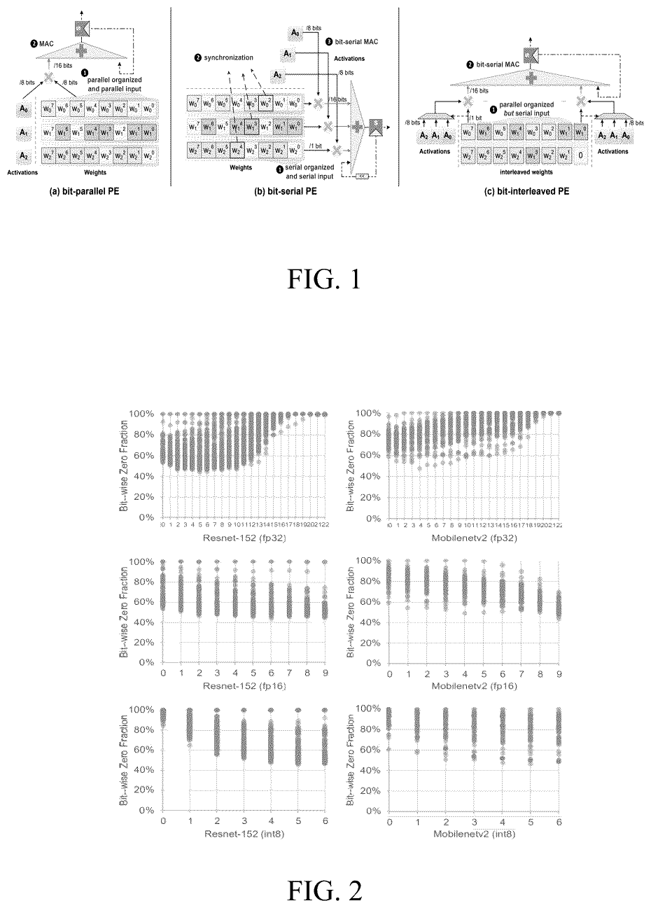

FIG. 1(c) shows a bit-interleaved process of the 8-bit fixed-point MAC, and demonstrates step by step. However, in actual application, the floating-point MAC is not easily utilized as the fixed-point MAC, because there is a special part, i.e., exponent, in the binary operand, and different operands have different exponents. In order to tap the potential of floating-point sparsity to the maximum extent, based on formula 5, bit interleaving includes three independent but continuous steps.

### 1 Pre-Processing

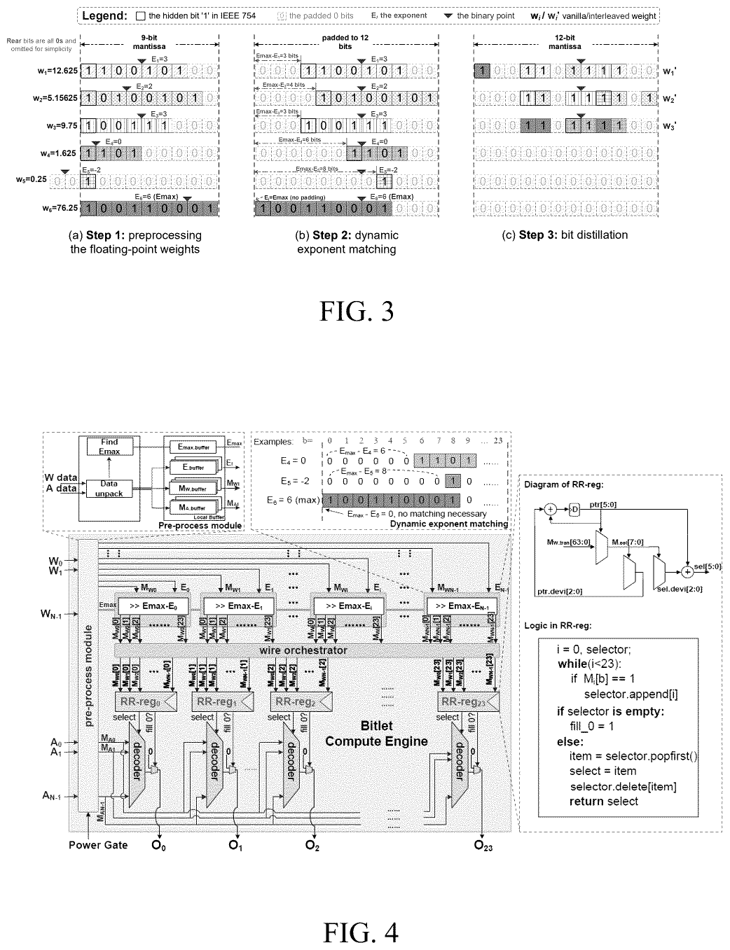

FIG. 3(a) uses one example for explanation, where six common 32-bit floating-point weights are arranged in rows, and the exponent and mantissa of each weight are random. The triangular mark represents actual position of the binary points. For simplicity, it does not mean that the actual 32-bit floating-point stored in the memory represents a binary format, but expresses values using more representative expressing method. For example, 0.012 in E₅=−2 represents denary 0.25 (W₅). This step is similar with the step 1 in FIG. 1(c), but here the 32-bit floating-point weights are parallel organized for interleaving. Moreover, these binary weights are pre-processed to obtain respective exponents and further determine the “maximum” exponent (E₆ in the example). Meanwhile, the mantissas are also stored for subsequent MAC computation. To simplify representation, mantissa bits (bit9 to bit23) of each mantissa are omitted.

### 2: Dynamic Exponent Matching:

The exponent represents position of decimal points in binary representation. Traditionally, it involves the “exponent matching” step in the floating-point addition. However, in bit interleaving, we often match by uniformly aligning a group of floating-point exponents to the maximum value (E₆ in the example), instead of processing one by one. The step is referred to as “dynamic exponent matching”, and FIG. 3(c) does not involve this step, because the fixed-point values do not have exponent.

Reviewing formula 5, in actual execution, the two summations can be parallel executed. External summation represents a vertical dimension in FIG. 3(a), i.e., N weights and their corresponding activations, and internal summation represents a horizontal dimension, i.e., different bit widths of the mantissa. As is seen from this angle, a key concept of formula 5 is to compute all M_{A}_{ᵢ} in M_{W}_{ᵢ}=1 along the two dimensions in FIG. 3(a).

Since our final goal is to compute Σᵢ₌₀^{N-1}Aᵢ×Wᵢ, it involves computation of N weights and activations. Therefore, all exponents are aligned to their maximum values in each execution, instead of gradually matching. As can be seen from FIG. 3(b), six weights are aligned to the maximum exponent, i.e., W₆. For example, W₅ shall be right shifted 8 bits to align with W₆. The advantage is that alignment of all exponents of the six weights shall be executed once only, thereby saving time and resource for efficient implementation of hardware.

### 3: Extraction of Necessary Bits

Currently, the key is how to obtain the accurate partial sum using necessary bits, and further obtain better inference speed. Considering of sparse parallelism mentioned above, the step extracts necessary bits using the feature, which is completely the same as the step 2 in FIG. 3(c).

As shown in FIG. 3(c), if we efficiently extract necessary bits 1, total computation can be reduced from MAC with six operands to MAC with three operands only. Still taking W₆ for example, an exponent of W₆ is 6, and the first bit (b=0) is the necessary bit 1. Under inspiration of formula 5, 2^{E}^{ₘₐₓ}^{+b} of the bit is equal to 2⁶, which means that the bit is the seventh position prior to the binary point. As for W₁ to W₅, bits at the position 2⁶ after alignment are all 0. If the first bit of W₆ is shifted upwardly, it replaces position of the same vertical lane in W₁, so A⁶×2⁶+A₁×2³ can be computed simultaneously. The necessary bits belonging to other weights also can be operated in the same manner, and finally, the extracted weights are in FIG. 3(c). To sum up, the two steps accelerate MACs of the floating-point 32-bit accuracy computation from two aspects: (1) avoiding computing high cost exponent matching operation; (2) eliminating invalid computation caused by 0 bits using sparse parallism.

### 2. Bitlet Accelerator

In order to execute bit interleaving, we design a new accelerator, which is named Bitlet. In this part, we will set forth key hardware design modules of Bitlet, including a microarchitecture for supporting multiple accuracy compute engines and an overall architecture for efficient memory access.

Key module 1—Pre-process module. Firstly, the present application designs a component involving two steps in “bit-interleaved” operation. Bitlet inputs multiple pairs of weights and activations, which are represented by N in FIG. 4. In the Bitlet compute engine (hereinafter referred to as BCE), W₀ to W_{N-1} are original weights, and A₀ to A_{N-1} are corresponding activations. The pre-process module divides each Wᵢ and Aᵢ into two parts, i.e., mantissa and exponent, and after executing Eᵢ=E_{W}_{ᵢ}+E_{A}_{ᵢ} on each A/W pair, selects the maximum exponent Eₘₐₓ and stores in the register for subsequent dynamic exponent matching operation. After Eₘₐₓ is determined, M_{W}_{ᵢ} is left (right) shifted Eₘₐₓ−Eᵢ_{ᵢ} bits, such that the exponent is consistent with that of Eₘₐₓ. Still taking the weights in FIG. 3 for example, E₆=6 in W₆ of the Eₘₐₓ bit, and other weights are all aligned with E₆, i.e., M_{W}_{₄} is shifted 6−0=6 bits, as shown in FIG. 4. Meanwhile, the left shifted position is automatically filled with 0, because the mantissa has a length of 24 bits, so the mantissa exceeding b=23 is discarded.

Key module 2—Wire orchestrator. After dynamic exponent matching, we obtain a 24-bit mantissa after shifting, which is represented by M_{W}_{ᵢ}[0] to M_{W}_{ᵢ}[23]. The mantissa is further sent to another module, which is referred to as a “wire orchestrator” in FIG. 4 for reorganizing circuits to output the matrix by column after gathering the same bit values together. Outputs of the orchestrator are represented by M_{W}_{₀}[b], M_{W}_{₁}[b], . . . , and M_{W}_{_{N-1}}[b], where bis in a range of 0 to 23. The module does not include any combinational logic or sequential logic, but only executing gathering operation and transposition operation on the aligned mantissas. Therefore, the module does not intuitively introduce obvious power consumption.

Key module 3—Circulating register RR-reg. RR-reg extracts necessary bits 1 (essential bits) in the interleaved weight, and selects outputs of the BCE from N activation mantissas. Each RR-reg has an internal clock, and is connected to a clock tree of the accelerator. As shown in FIG. 4, pseudo codes represent a specific program: firstly, RR-reg sequentially extracts the necessary bits 1 sequentially according to input bits. A “Select” signal indicates that decoders are configured with an activation path and an output Oᵢ to be selected. If the necessary bits 1 are not detected, RR-reg activates a “fill 0” signal, and Oᵢ is also outputted to be 0. The “fill 0” signal operation is suitable for the case where all bits in each bit row are 0, i.e., the scenario where b=1 or 2 in FIG. 3(c).

The BCE has the following three features: \textcircled{1} the architecture does not bring accuracy loss, because the dynamic exponent matching is the same as the floating-point operation in IEEE 754. The rightmost bits after shifting are discarded in the operation, but these bit values are tiny and can be ignored without influence on accuracy. \textcircled{2} The BCE does not require any pre-processing on parameter sparsity. The pre-process module in FIG. 4 is only responsible for converting activations of the weights into the corresponding mantissas and exponents. In actual RTL implementation, each RR-reg implements a sliding window to automatically interleave and extract necessary bits. Benefiting from favorable conditions of sparse parallelism, each RR-reg almost can complete extraction of M_{W}_{ᵢ}^{b} simultaneously. \textcircled{3} In addition to RR-reg, the BCE is mainly consisting of a combinational circuit, but not involving complex circuits that may lead to delay and prolonging of critical paths. Each RR-reg produces an output Oᵢ in each clock cycle, but as compared to the traditional MAC in one-to-one correspondence, a total cycle for computing the partial sum is greatly optimized. N is a sole design parameter in the BCE, and large N facilitates extracting more bits 1.

### 3. Architecture of the Accelerator

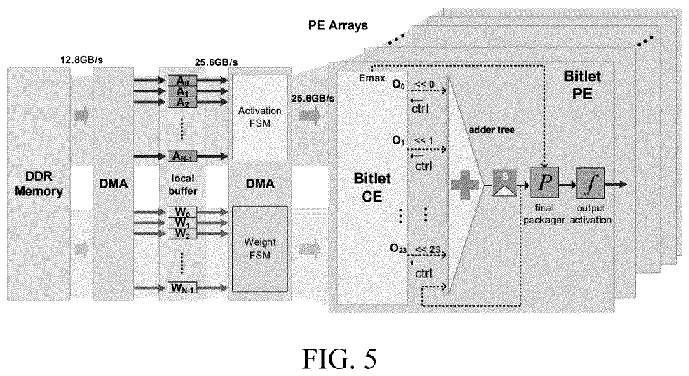

PE: Bitlet is formed of mesh-connected PEs. As shown in FIG. 5, each PE is formed of a BCE and an adder tree. The BCE is connected to an on-chip buffer and the adder tree. Each PE serial inputs N weights and activations, and produces the partial sum Oᵢ as an input of the adder tree. Since outputs of the BCE are limited by the 24-bit mantissa, the inputs of the adder tree are also 24. PE finally determines the result by multiplying 2^{E}^{ₘₐₓ}^{+b} (please note that b is a negative number) to ensure correctness of the result. 2^{E}^{_{max+b}} can be divided into a fixed part b and a common part Eₘₐₓ for producing outputs of the BCE. Execution of the fixed part may be completed by a fixed number of shiftings. Eₘₐₓ only shall be executed on result of the accumulator. Computing Oᵢ only shall perform fixed-point addition on mantissas of the activations, and does not include any multiplication, which also means that arithmetic complexity and power consumption are also optimized corresponding.

Memory system: in order to achieve high throughput, the Bitlet accelerator provides a separated DMA lane for activations and weights. As shown in FIG. 5, a local buffer stores data acquired from a DDR3 memory, and provides enough bandwidth for corresponding access of the Bitlet PE. In RTL implementation, the bandwidth of each lane between the memory and the local buffer reaches 12.8 GB/s, and the PE array can obtain activation and weight data from the local buffer using a total bandwidth of 25.6 GB/s. In a data stream mode, the Bitlet reduces main memory access using weight and activation fixed broadcasting mechanism.

### 4. Flexibility of Bitlet

The Bitlet accelerator supports multiple accuracy computation, can be conveniently configured to be a fixed-point mode, and provides enough flexibility for terminal users. For example, if using 16-bit fixed-point accuracy, the pre-process module for executing exponent matching and shifting (>>Eₘₐₓ−E_{W}_{ᵢ} in FIG. 4) may be partially gate, and the input Wᵢ is directly connected to the wire orchestrator. Bitlet is initially designed to support a 24-bit mantissa, so if using 16-bit fixed-point accuracy, only RR-reg₀ to RR-reg₁₅ participate. Other RR-reg can be safety closed or held in an empty state. Int8 quantization or any other target accuracy (i.e., int4, int9, etc.) is similar to such processing. Therefore, it is unnecessary for the terminal users to relay on other specific accuracy accelerators to suit for different use conditions. Users can freely configure DNN to satisfy balance between accuracy goal and power consumption/performance.

Hereinafter system embodiment corresponding to the method embodiment is explained, and this embodiment can be carried out combining with the above embodiment. The relevant technical details mentioned in the above embodiment are still effective in this embodiment, and in order to reduce repetition, the details are not described here. Correspondingly, relevant technical details mentioned in this embodiment also can be applied to the above embodiment.

The present application further provides a processor for carrying out the deep learning convolution acceleration method using bit-level sparsity.

The processor comprises:
a pre-process module for acquiring multiple groups of data pairs to be convolved, wherein each group of data pairs is formed of an activation and a corresponding original weight, and the activation and the original weight are both floating-point numbers; summing exponents of the activation and the original weight in each group of data pairs to obtain a sum of the exponents of each group of data pairs, and selecting the maximum sum of the exponents from all data pairs as a maximum exponent;
an exponent alignment module for arranging mantissas of the original weights in a computation sequence to form a weight matrix, and uniformly aligning each row of the weight matrix to the maximum exponent to obtain an alignment matrix;
a weight interleaved module for removing slack bits in the alignment matrix to obtain a reduced matrix with vacancies, allowing essential bits in each column of the reduced matrix to fill the vacancies according to the computation sequence to form an intermediate matrix, and after removing null rows in the intermediate matrix, placing zeros at vacancies of the matrix to obtain an interleaved weight matrix, wherein each row of the interleaved weight matrix serves as a necessary weight; and
a circulating register for extracting essential bits in the necessary weight, and obtaining positional information of the activation corresponding to each bit of the necessary weight from the corresponding mantissa in the mantissas of all activations; and
a split accumulator for dividing the necessary weight by bit into multiple weight segments, sending the weight segments and the mantissa of the corresponding activation to an adder tree for processing summation according to the positional information, and obtaining an output feature map as a convolution result of the multiple groups of data pairs by means of executing shift-and-add on the processing result.

In the processor, the activations are pixel values of an image.

### INDUSTRIAL APPLICABILITY

The present application provides a deep learning convolution acceleration method using bit-level sparsity, and a processor. The method comprises: acquiring multiple groups of data pairs to be convolved, summing exponents of the activation and the original weight in each group of data pairs to obtain a sum of the exponents of each group of data pairs, and selecting the maximum sum of the exponents from all data pairs as a maximum exponent; arranging mantissas of the original weights in a computation sequence to form a weight matrix, and uniformly aligning each row of the weight matrix to the maximum exponent to obtain an alignment matrix; removing slack bits in the alignment matrix to obtain a reduced matrix, allowing essential bits in each column of the reduced matrix to fill the vacancies according to the computation sequence to form an intermediate matrix, after removing null rows in the intermediate matrix, placing zeros at vacancies of the matrix to obtain an interleaved weight matrix, sending the weight segments in each row of the interleaved weight matrix and the mantissa of the corresponding activation to an adder tree for processing summation, and obtaining an output feature map as a convolution result of the multiple groups of data pairs by means of executing shift-and-add on the processing result.

What is claimed is:

1. A deep learning convolution acceleration method using bit-level sparsity, comprising:
step 1, acquiring multiple groups of data pairs to be convolved, wherein each group of data pairs is formed of an activation and a corresponding original weight, and the activation and the original weight are both floating-point numbers;
step 2, summing exponents of the activation and the original weight in each group of data pairs to obtain a sum of the exponents of each group of data pairs, and selecting the maximum sum of the exponents from all data pairs as a maximum exponent;
step 3, arranging mantissas of the original weights in a computation sequence to form a weight matrix, and uniformly aligning each row of the weight matrix to the maximum exponent to obtain an alignment matrix;
step 4, removing slack bits in the alignment matrix to obtain a reduced matrix with vacancies, allowing essential bits in each column of the reduced matrix to fill the vacancies according to the computation sequence to form an intermediate matrix, and after removing null rows in the intermediate matrix, placing zeros at vacancies of the matrix to obtain an interleaved weight matrix, wherein each row of the interleaved weight matrix serves as a necessary weight; and
step 5, obtaining, according to a correspondence relationship between the activations and the essential bits in the original weights, positional information of the activation corresponding to each bit of the necessary weight, sending the necessary weight to a split accumulator, which divides the necessary weight by bit into multiple weight segments, sending the weight segments and the mantissa of the corresponding activation to an adder tree for processing summation according to the positional information, and obtaining an output feature map as a convolution result of the multiple groups of data pairs by means of executing shift-and-add on the processing result.

2. The deep learning convolution acceleration method using bit-level sparsity according to claim 1, wherein the activations are pixel values of an image.

3. A processor for carrying out the deep learning convolution acceleration method using bit-level sparsity according to claim 1.

4. The processor according to claim 3, comprising:
a pre-process module for acquiring multiple groups of data pairs to be convolved, wherein each group of data pairs is formed of an activation and a corresponding original weight, and the activation and the original weight are both floating-point numbers; summing exponents of the activation and the original weight in each group of data pairs to obtain a sum of the exponents of each group of data pairs, and selecting the maximum sum of the exponents from all data pairs as a maximum exponent;
an exponent alignment module for arranging mantissas of the original weights in a computation sequence to form a weight matrix, and uniformly aligning each row of the weight matrix to the maximum exponent to obtain an alignment matrix;
a weight interleaved module for removing slack bits in the alignment matrix to obtain a reduced matrix with vacancies, allowing essential bits in each column of the reduced matrix to fill the vacancies according to the computation sequence to form an intermediate matrix, and after removing null rows in the intermediate matrix, placing zeros at vacancies of the matrix to obtain an interleaved weight matrix, wherein each row of the interleaved weight matrix serves as a necessary weight; and
a circulating register for extracting essential bits in the necessary weight, and obtaining positional information of the activation corresponding to each bit of the necessary weight from the corresponding mantissa in the mantissas of all activations; and
a split accumulator for dividing the necessary weight by bit into multiple weight segments, sending the weight segments and the mantissa of the corresponding activation to an adder tree for processing summation according to the positional information, and obtaining an output feature map as a convolution result of the multiple groups of data pairs by means of executing shift-and-add on the processing result.

5. The processor according to claim 4, wherein the activations are pixel values of an image.
